(19) United States
(12) Patent Application Publication
(10) Pub. No.: US 2015/0177908 A1
(43) Pub. Date: Jun. 25, 2015

(54) INPUT SYSTEM AND RECORDING MEDIUM

(71) Applicant: SHARP KABUSHIKI KAISHA, Osaka-shi, Osaka (JP)

(72) Inventor: Tatsuro Kuroda, Osaka-shi (JP)

(73) Assignee: Sharp Kabushiki Kaisha, Osaka-shi, Osaka (JP)

(21) Appl. No.: 14/403,465

(22) PCT Filed: May 20, 2013
(86) PCT No.: PCT/JP2013/063882

§ 371 Date: Nov. 24, 2014

(30) Foreign Application Priority Data
May 24, 2012 (JP) 2012-119015

(51) Int. Cl. G06F 3/042

(52) U.S. Cl. CPC G06F 3/0421

(57) ABSTRACT

An input system includes a plurality of input devices that communicates with a touch panel apparatus, and are used to point out positions on a display screen of the touch panel apparatus, wherein each of the input devices includes a transmitting unit configured to transmit a status signal representing a contact state of the input device with the display screen, a determination unit configured to determine a transmission order of the status signal based on a relationship with other input devices and a signal detection unit configured to detect an end of transmission of the status signal from another input device of which the determined transmission order is previous, and the touch panel apparatus includes a position detection unit configured to detect a position as an input position of the input device that is a transmission source of the status signal, when the touch panel apparatus receives the status signal and detect a contact of the input device with the display screen.

### TECHNICAL FIELD

The present invention relates to a touch panel apparatus having a contact surface, an input system including a plurality of input devices used to point out positions on the contact surface, an input device used in the input system, and a recording medium recorded with a computer program for controlling the input device.

### BACKGROUND ART

Recently, an optical touch panel which includes a plurality of light emitting devices disposed around a contact surface and a plurality of light receiving devices respectively corresponding to the plurality of light emitting devices to detect positions of light-shielding objects on the contact surface has been proliferated.

In an input device of the optical touch panel, the plurality of light emitting devices are arranged in an x-axis direction and a y-axis direction along edges of a rectangular display screen and the plurality of light receiving devices are arranged at positions corresponding to the light emitting devices along edges of the rectangular display screen. Light emitted from the respective light emitting devices is propagated along the surface of the display screen and is received by the light receiving devices disposed at a position facing the light emitting devices. When a user points out a position on the display screen using a finger or an input device such as a pen, a light receiving device that cannot receive the light due to the light being shielded may occur. The optical touch panel specifies the position of the light receiving device which cannot receive the light among the light receiving devices arranged in the x-axis direction and the y-axis direction to detect coordinates of the positions pointed out by the user on the display screen. When the user continuously moves the pointed positions on the display screen, the optical touch panel stores a history of the pointed positions, and thereby it is possible to detect a trace of the positions pointed out by the user on the display screen. In addition, the optical touch panel displays the detected trace on the display screen, thereby it is also possible to perform a drawing.

Further, in the optical touch panel apparatus, an input device sending a signal at the time of contacting the display screen may be used. Such an input device may prevent the occurrence of erroneous recognition that the input device is in a contact state with the display screen even though the input device is in a non-contact state in which it is apart from the display screen.

### PRIOR ART DOCUMENT

### Patent Document

[Patent Document 1] Japanese Patent Laid-Open No. 2006-99273

### SUMMARY OF THE INVENTION

### Problems to be Solved by the Invention

However, when a plurality of input devices are used in the optical touch panel apparatus, there is a problem that the signals from the input devices are likely to interfere with each other.

Further, to solve the above-described problems, Patent Document 1 discloses a technique of identifying a plurality of indicating tools by allocating identifiers to each of indicating tools and sending signals including the identifiers using infrared light as a carrier. However, the technique disclosed in Patent Document 1 sets the identifiers for each of indicating tools and encodes and sends the identifiers every time the indicating tools are pen-downed (contact the display screen). Therefore, there is a problem that the entire responsiveness of the touch panel apparatus may be degraded due to the processing time required to execute the decode processing of the identifiers.

In consideration of the above-described circumstances, it is an object of the present invention to provide an input system capable of preventing the occurrence of interference by allowing each of input devices to transmit and receive signals in a time division manner, an input device, and a recording medium.

In addition, another object of the present invention is to provide an input system having a good responsiveness since processing relating to encoding is not required.

### Means for Solving the Problems

An input system according to the present invention includes a touch panel apparatus having a contact surface, and a plurality of input devices used to point out positions on the contact surface, wherein the touch panel apparatus detects a position in which the input device contacts the contact surface as an input position, wherein the touch panel apparatus and the plurality of input devices respectively communicate with each other, each of the input devices comprises: a transmitting unit configured to transmit status signals representing a contact state of the input device with the contact surface; a determination unit configured to determine a transmission order of the status signals based on a relationship with other input devices; and a signal detection unit configured to detect an end of transmission of the status signal from another input device of which the determined transmission order is previous, wherein the transmitting unit is configured to start the transmission of the status signal based on the detection of the signal detection unit, and

the touch panel apparatus includes: a position detection unit configured to, when the position in which the input device contacts the contact surface is detected during receiving a status signal representing a state in contact with the contact surface, detect the detected position as an input position by the input device of a transmission source of the status signal.

The input system according to the present invention is characterized in that a transmission time length of the status signal is set to different time lengths for each of the input devices.

The input system according to the present invention is characterized in that each of the input devices further comprises a first detection unit configured to detect a contact with the display screen, the transmitting unit is configured to transmit the status signal when the first detection unit detects that the input device is in contact with the display screen, and the determination unit is configured to determine a transmission order of the status signals of the respective input devices based on order in which the input devices transmit the status signals or order in which the touch panel apparatus receives the status signals.

The input system according to the present invention is characterized in that the touch panel apparatus further includes a plurality of light emitting devices disposed around the display screen and a plurality of light receiving devices respectively corresponding to the plurality of light emitting devices, wherein the touch panel apparatus detects a position in which the input device contacts with the display screen based on a result that light emitted from each of the light emitting devices is respectively received in the light receiving devices corresponding thereto, and each of the input devices further comprises a second detection unit configured to detect the light emitted from each of the light emitting devices, the transmitting unit is configured to transmit the status signal when the second detection unit detects the light, and the determination unit is configured to determine the transmission order of the status signals of the respective input devices based on order in which the input devices transmit the status signals or order in which the touch panel apparatus receives the status signals.

The input system according to the present invention is characterized in that a time at which the transmission of the status signal starts after the first detection unit detects that the input device is in contact with the display screen is set differently in each of the input devices.

The input system according to the present invention is characterized in that a time at which the transmission of the status signal starts after the signal detection unit detects the end of the transmission is set differently in each of the input devices.

The input system according to the present invention is characterized in that each of the input devices further includes an operation unit configured to receive an operation, the transmitting unit is configured to transmit an operation signal when the operation unit receives the operation, and the status signal and the operation signal are pulse signals of which at least one of a pulse width, a pulse period, and a transmission time length is different.

The input system according to the present invention is characterized in that the status signal is a pulse signal, each of the input devices further includes an operation unit configured to receive an operation and a modulation unit configured to modulate a pulse signal by at least one of the contact state of the input device with the display screen, the operation received by the operation unit, and a setting relating to the input device itself.

An input device according to the present invention is characterized in that the input device which is used in a touch panel apparatus having a contact surface to point out a position by a contact to the contact surface thereof, comprising a transmitting unit configured to transmit status signals representing a contact state of the input device with the contact surface to the touch panel apparatus and other input devices a determination unit configured to determine a transmission order of the status signals based on a relationship with other input devices and a signal detection unit configured to detect an end of transmission of the status signals of another input device of which the determined transmission order is previous, wherein the transmitting unit is configured to start the transmission of the status signal based on the detection of the signal detection unit.

A non-transitory recording medium according to the present invention is characterized in that the non-transitory recording medium readable by a computer in which a computer program for controlling an operation of a plurality of input devices is recorded, in an input system in which a touch panel apparatus having a display screen and the plurality of input devices used to point out positions on the display screen are configured to respectively communicate with each other and detect a contact position of each input devices on the display screen as an input position, said computer program executing, determining a transmission order of status signals representing a contact state with the display screen based on a relationship with other input devices, detecting an end of transmission of the status signals of other input devices of which the determined transmission order is previous and starting the transmission of the status signals based on the detection of the end of the transmission of the status signals of other input devices.

According to the present invention, it is possible to prevent the occurrence of interference by allowing each of input devices to transmit and receive the status signals in a time division manner.

### Effect of the Invention

In the input system, the input device, the computer program, and the recording medium according to the present invention, the plurality of input devices transmit and receive the status signals in the time division manner in cooperation with each other. As described above, since the status signals are transmitted in the time division manner, excellent effects such as preventing the status signals from interfering with each other may be exhibited.

Further, it is possible to eliminate the encode/decode processing at the time of transmitting and receiving the signals, in this case, it provided such a superior effect that it is possible to prevent an increase in a processing load.

### BRIEF DESCRIPTION OF THE DRAWINGS

FIG. 1 is a schematic view illustrating an example of an input system according to Embodiment 1 of the present invention.

FIG. 2 is a schematic view illustrating an example of an input device according to Embodiment 1 of the present invention.

FIG. 3 is a schematic cross-sectional view illustrating an example of the input device according to Embodiment 1 of the present invention.

FIG. 4 is a block diagram illustrating an example of an internal configuration of the touch panel apparatus and the input device according to Embodiment 1 of the present invention.

FIG. 5 is a schematic conceptual diagram illustrating an example of light emitting devices, light receiving devices, and optical paths which are disposed in the touch panel apparatus according to Embodiment 1 of the present invention.

FIG. 6 is a timing chart sequentially illustrating an example of a transmission output of status signals transmitted by the input devices according to Embodiment 1 of the present invention.

FIG. 7 is a flow chart illustrating an example of the transmission processing of the status signal from the input device according to Embodiment 1 of the present invention.

FIG. 8 is a flow chart illustrating an example of processing of detecting an input position of the touch panel apparatus according to Embodiment 1 of the present invention.

FIG. 9 is a timing chart sequentially illustrating an example of the transmission output of the status signals and operation signals transmitted by input devices according to Embodiment 2 of the present invention.

FIG. 10 is a timing chart sequentially illustrating an example of the transmission output of the status signals and the operation signals transmitted by the input devices according to Embodiment 2 of the present invention.

FIG. 11 is a timing chart sequentially illustrating an example of the transmission output of the status signals transmitted by the input devices according to Embodiment 3 of the present invention.

FIG. 12 is a diagram for describing an example of a format of the status signal according to Embodiment 3 of the present invention.

FIG. 13 is a flow chart illustrating an example of the transmission processing of the status signals from the input device according to Embodiment 3 of the present invention.

FIG. 14 is a schematic diagram schematically illustrating an example of a contact condition of the touch panel apparatus and input devices in the input system according to Embodiment 4 of the present invention.

FIG. 15 is a timing chart sequentially illustrating an example of the transmission output of the status signals transmitted by the input devices according to Embodiment 4 of the present invention.

FIG. 16 is a timing chart sequentially illustrating an example of the transmission output of the status signals transmitted by input devices according to Embodiment 5 of the present invention.

FIG. 17 is a timing chart sequentially illustrating an example of the transmission output of the status signals transmitted by the input devices according to Embodiment 6 of the present invention.

FIG. 18 is a schematic diagram illustrating an example of the contact condition of the touch panel apparatus and the input devices in the input system according to Embodiment 7 of the present invention.

FIG. 19A is a schematic view illustrating an example of the input device according to Embodiment 7 of the present invention.

FIG. 19B is a schematic view illustrating an example of the input device according to Embodiment 7 of the present invention.

FIG. 20 is schematic diagram illustrating an example of the input device according to Embodiment 7 of the present invention.

### MODES FOR CARRYING OUT THE INVENTION

Hereinafter, the present invention will be described in detail with reference to the accompanying drawings illustrating the embodiments thereof.

### Embodiment 1

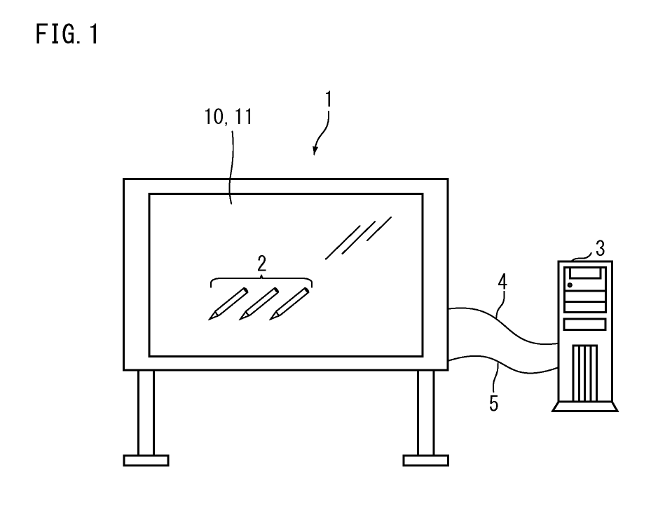

FIG. 1 is a schematic view illustrating an example of an input system according to Embodiment 1 of the present invention. The input system according to Embodiment 1 includes an optical touch panel apparatus 1 and a plurality of input devices 2, 2, . . . which input various instructions or information through the touch panel apparatus 1. According to the present embodiment, the input device 2 is, for example, a touch pen, a stylus pen, or the like and serves as a pointing device. Further, the touch panel apparatus 1 is connected to a computer 3 to be described below.

Further, when distinguishably describing each input device 2, 2, . . . in the following description, the input device is represented by a first input device 2a, and a second input device 2b, . . . .

The touch panel apparatus 1 includes a display panel 10 with a rectangular display screen which displays images, characters, and the like thereon and an input panel 11 which is disposed to cover the display screen of the display panel 10 and receives an input of various instructions or information by a user.

The display panel 10 includes a liquid crystal display, an EL (electroluminescence) display or the like. For example, an image is displayed thereon based on an image signal output from the computer 3.

The input panel 11 includes a rectangular operation plane (contact surface). The input panel 11 optically detects that a light-shielding object such as a user's finger or the input device 2 contacts the operation plane so as to process contact positions on the operation plane as an input of position information. The user contacts the operation plane of the input panel 11 with the finger, the input device 2, or the like according to the images displayed on the display screen of the display panel 10 to input various instructions or information depending on the position information of the contact positions.

The computer 3 includes, for example, a personal computer. The touch panel apparatus 1 and the computer 3 are connected with each other through a first cable 4 based on a USB standard, or the like and a second cable 5 based on a HDMI standard or the like. The first cable 4 is mainly used to transmit position information representing positions of the light-shielding object detected by the touch panel apparatus 1 to the computer 3. The second cable 5 is mainly used to transmit the image signal for displaying the image on the display panel 10 from the computer 3 to the touch panel apparatus 1.

The input devices 2, 2, . . . may communicate with the touch panel apparatus 1 by wireless communication using electromagnetic waves such as ultrasonic waves and the input devices 2, 2, . . . may communicate with each other therethrough.

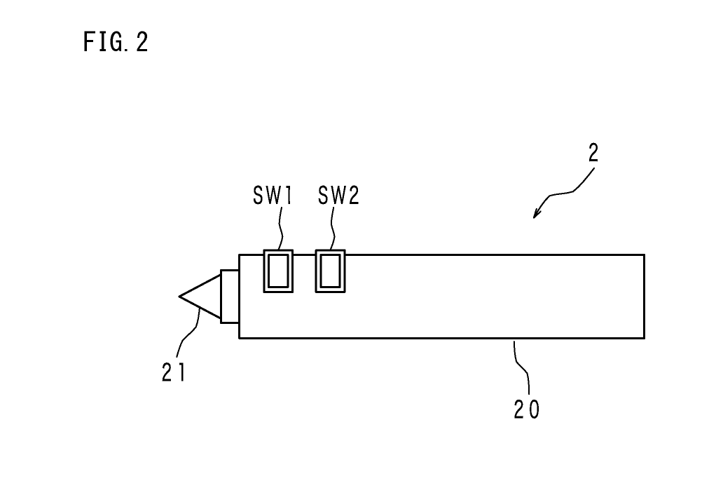

FIG. 2 is a schematic view illustrating an example of the input device 2 according to Embodiment 1 of the present invention. The input device 2 has a configuration in which a bottom portion of a conical pen tip part 21 is inserted into a bottom side of one end of a main body part 20 formed in an elongated cylindrical shape. The pen tip part 21 of the input device 2 is contacted and pressed to the operation plane of the input panel 11, the pen tip part 21 is slid up to a predetermined depth inward of the main body part 20.

The main body part 20 is provided with a first switch SW1 and a second switch SW2. The first switch SW1 and the second switch SW2 may appropriately set functions such as mode change. As a mode assigned to the first switch SW1 and the second switch SW2, there are various modes such as a selection of icons, kinds of lines, a line width, a handwriting mode (a pen mode), an erase mode (an eraser mode) and the like.

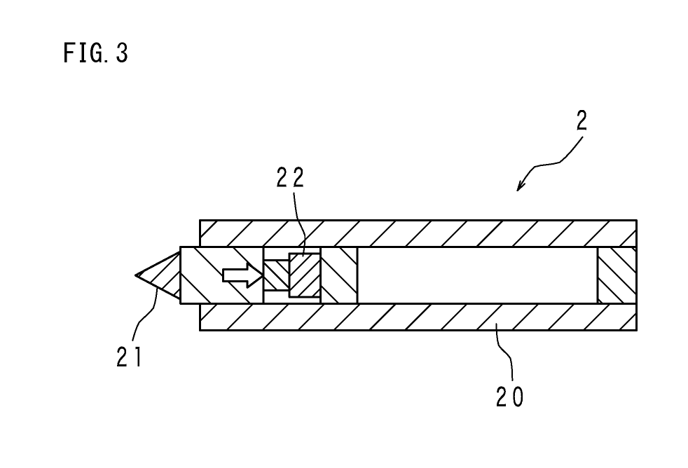

FIG. 3 is a schematic cross-sectional view illustrating an example of the input device 2 according to Embodiment 1 of the present invention. FIG. 3 illustrates, in particular, a cross-section of the pen tip part 21 as an example of an axial cross-section of the input device 2. A state detection unit 22 (first detection unit) such as a push down type switch or a pressure sensor is disposed inside of the main body part 20 toward the bottom portion of the pen tip part 21.

When the pen tip part 21 contacts the operation plane of the touch panel apparatus 1 such that the bottom portion thereof is slid into the main body part 20, the pen tip part abuts and presses the state detection unit 22. The state detection unit 22 detects that the pen tip part 21 is in contact with the operation plane, when detecting the pressing by the bottom portion. Further, if the state detection unit 22 can detect whether a tip of the pen tip part 21 contacts the operation plane, it is not limited to a mechanical state detection unit 22 illustrated in FIG. 3, and various kind of state detection units 22 such as a pressure-sensitive sensor and various sensors detecting an electrical change may be used. In this case, the state detection unit 22 may be configured to be provided at the tip of the pen tip part 21.

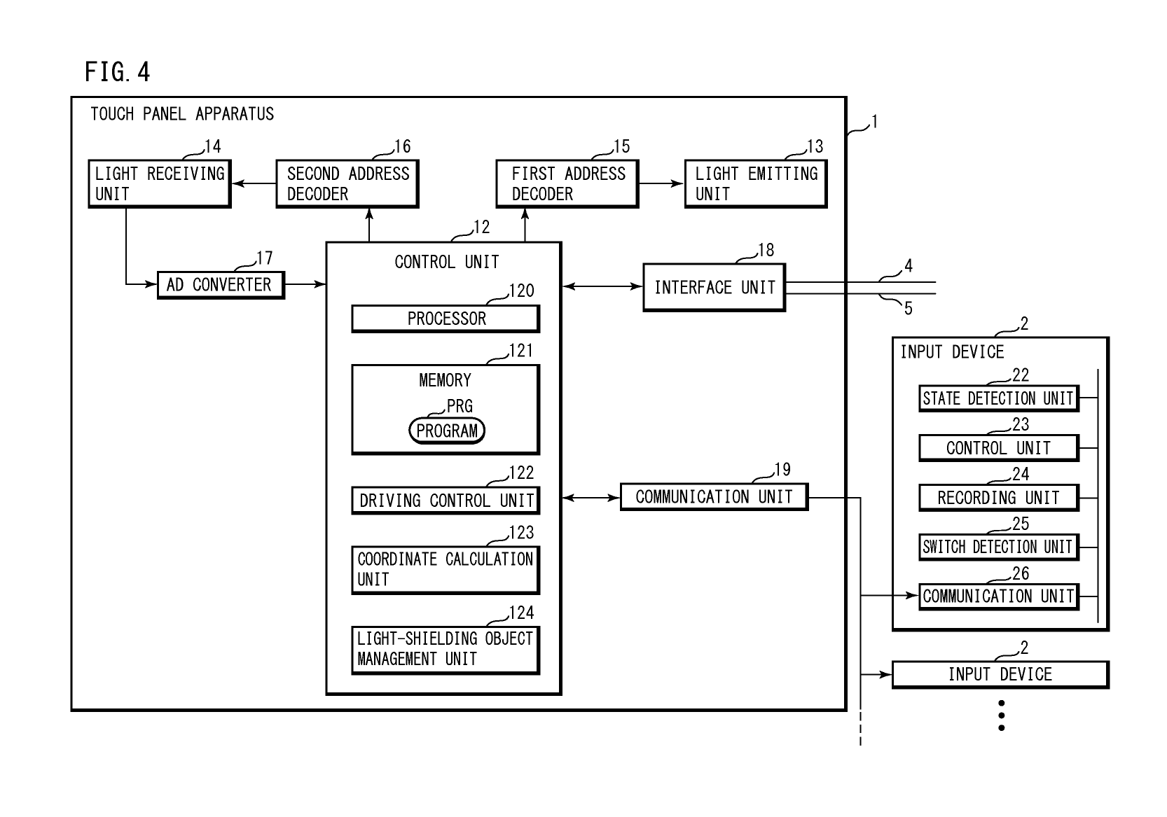

FIG. 4 is a block diagram illustrating an internal configuration example of the touch panel apparatus 1 and the input device 2 according to Embodiment 1 of the present invention. The touch panel apparatus 1 includes a control unit 12 which controls the entire apparatus, and further includes devices such as a light emitting unit 13, a light receiving unit 14, a first address decoder 15, a second address decoder 16, and an A/D converter 17 and the like. Further, the touch panel apparatus 1 includes an interface unit 18 and a communication unit 19.

The control unit 12 includes a processor 120 and a memory 121, and further includes circuits such as a driving control unit 122, a coordinate calculation unit 123, a light-shielding object management unit 124 and the like. The memory 121 is a nonvolatile or volatile recording means, and is recorded with various programs such as program PRG for controlling operations of the respective parts of hardware included in the touch panel apparatus 1, information on data and the like. Further, by executing various programs such as the program PRG recorded in the memory 121, the processor 120 executes processing as the touch panel apparatus 1 included in the input system according to the present invention. Further, the same function as the program PRG may be installed as hardware, not as a software program.

Further, various information such as a transmission order obtained by communication with the input devices 2, 2, . . . , as well as various information such as a preset transmitting time of the input devices 2, 2, . . . is recorded into the memory 121.

The driving control unit 122 is a circuit controlling a driving of light emitting devices 130, 130, . . . and light receiving devices 140, 140, . . . which will be described below. The coordinate calculation unit 123 is a circuit which executes processing of calculating coordinates representing positions of the light-shielding objects contacting the operation plane. When a plurality of light-shielding objects are used, the light-shielding object management unit 124 is a circuit executing processing of managing contact positions and contact traces for each of the light-shielding objects. Further, the configuration such as the driving control unit 122, the coordinate calculation unit 123, the light-shielding object management unit 124, and the like may be configured as a circuit such as an LSI chip which is hardware, and may also be configured as a software program.

The light emitting unit 13 includes the plurality of light emitting devices 130, 130, . . . including LEDs which emit light such as infrared light. The light receiving unit 14 includes the plurality of light receiving devices 140, 140, . . . including photo diodes which receive light such as infrared light. When the light-shielding objects are not present on the surface, the respective light receiving devices 140, 140, . . . may be configured to receive the infrared light emitted from the light emitting devices 130, 130, . . . respectively corresponding thereto.

The light emitting unit 13 is connected to the first address decoder 15. The first address decoder 15 receives an input of control signals for scanning sequentially the plurality of light emitting devices 130, 130, . . . from the control unit 12 and outputs select signals to the light emitting unit 13, such that the light emitting devices 130, 130, . . . which are sequentially selected based on the control signals for emitting light sequentially. The second address decoder 16 receives an input of control signals for scanning sequentially the plurality of light receiving devices 140, 140 from the control unit 12 and outputs select signals to the light receiving unit 14, such that the light receiving devices 140, 140, . . . which are sequentially selected based on the control signals for receiving the infrared light emitted from the light emitting devices 130, 130, . . . respectively corresponding thereto.

The light receiving unit 14 is connected to the A/D converter 17, and the light receiving devices 140, 140, . . . receiving the infrared light output intensity signals for representing the intensity of the received infrared light by a voltage value to the A/D converter. The A/D converter 17 converts the intensity signal input from the light receiving devices to, for example, an 8-bit digital signal and outputs the intensity signal converted to a digital signal to the control unit 12.

The touch panel apparatus 1 configured as described above executes processing of determining whether the light-shielding object contacting the operation plane is present, and when the contacting light-shielding object is present, executes processing of calculating the positions of the light-shielding object, by the control unit 12.

That is, by the driving control unit 122, the control unit 12 repeats processing of transmitting the control signal to the light emitting unit 13 and the light receiving unit 14 through the first address decoder 15 and the second address decoder 16, and sequentially acquiring an intensity signal from all the light receiving devices 140, 140, . . . . The control unit 12 calculates amounts of light received by the light receiving devices 140, 140, . . . based on the sequentially acquired intensity signals. Further, when the calculated amount of received light exceeds a preset threshold value, the control unit 12 determines that an optical path between the light receiving device 140 relating to the amount of received light and the light emitting device 130 corresponding thereto is not intercepted, and the light-shielding object is not present on the optical path. Further, when the calculated amount of received light is equal to or less than the preset threshold value, the control unit 12 determines that the optical path between the light receiving device 140 relating to the amount of received light and the light emitting device 130 corresponding thereto is intercepted, and the light-shielding object is present in the optical path. Further, the control unit 12 specifies the light receiving devices 140, 140, . . . relating to the optical path of the intercepted infrared light and calculates coordinates representing the light-shielding object contacting the operation plane from the specified light receiving devices 140, 140, . . . , by the coordinate calculation unit 123.

Further, when the light-shielding objects are the input devices 2, 2, . . . processing of specifying the input device 2 that is in contact with the surface among the input devices 2, and processing of associating the contacting input devices 2, 2, . . . with the contacting positions are executed. The processing of specifying the input device 2 that is in contact with the surface is performed by determining whether a status signal representing that the input device 2 is in a contact state is transmitted therefrom.

The interface unit 18 includes a connection terminal connecting the first cable 4 and the second cable 5, and a control circuit relating to the connection. Further, the interface unit 18 may include a slot loaded with a recording a medium such as a flash memory and the connection circuit relating to the connection.

The communication unit 19 includes an antenna communicating with the input devices 2, 2, . . . using electromagnetic waves such as ultrasonic waves and a control circuit relating to the communication.

The input device 2 includes a control unit 23 including an MPU controlling over the whole and a RAM which stores temporarily generated data, and the like, and a recording unit 24 such as a flash memory. Further, the input device 2 includes the above- described state detection unit 22, a switch detection unit 25 for detecting the pressing of the first switch SW1 and the second switch SW2, and a communication unit 26. The communication unit 26 communicates with the touch panel apparatus 1 and other input devices 2, 2, . . . using the electromagnetic waves such as ultrasonic waves.

The recording unit 24 is a recording medium in which a computer program, and the like for controlling the operation of the input device 2 is recorded. The control unit 23 controls the operations of each part of hardware included in the input device 2 by reading the computer program recorded in the recording unit 24 to the RAM within the control unit 23 and executing the computer program by the MPU to operate the whole as the input device according to the present invention. Further, the recording unit 24 is recorded with various data such as a cyclic transmission order of the status signals, setting of a transmission time length of the status signal, and the like which will be described below.

Further, the computer program according to the present invention may be configured to be provided as a portable recording medium (not illustrated) in which an executable format program, an intermediate code program, a source program, and the like are recorded. In this case, for example, the user performs an operation of recording the computer program recorded in the recording medium in the recording unit 24, and thus the computer program may be in an executable state in the control unit 23, and the input device according to the present invention may be implemented. As the portable recording medium, various media such as magnetic recording media such as a magnetic tape, a flexible disk, and a hard disk, optical media such as CD, MO, MD, and semiconductor recording media such as DVD, a mask ROM, an EPROM, and a flash ROM may be used. The input device 2 need not include a read means for reading the computer program from the recording medium and may be configured to be input from external apparatuses using a communication means such as a wireless LAN and a USB.

When detecting that the pen tip part 21 is in a contact state with the operation plane, the state detection unit 22 transmits the status signal representing that the pen tip part is in a non-contact state with the operation plane from the communication unit 26. The touch panel apparatus 1 receives the transmitted status signal from the communication unit 19. Further, the input device 2 receives the status signals, which are transmitted from other input devices 2, 2, . . . , from the communication unit 26.

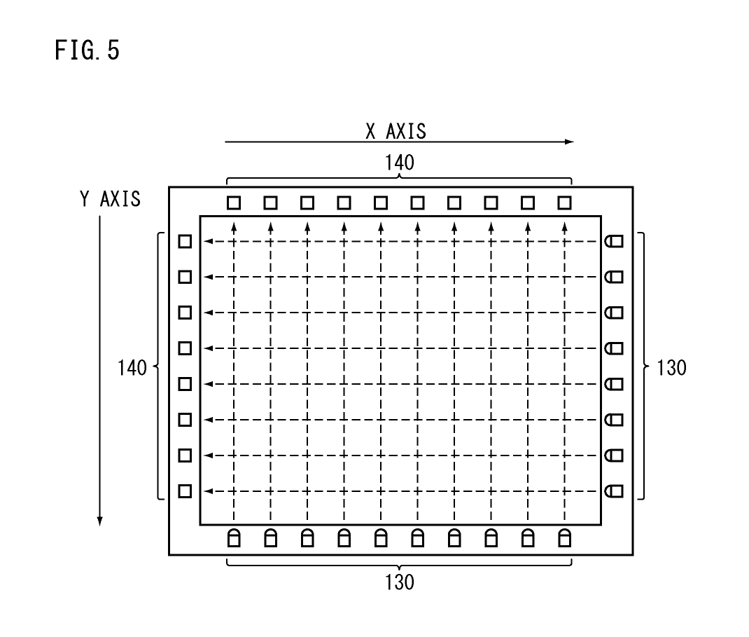

FIG. 5 is a schematic conceptual diagram illustrating an example of the light emitting devices 130, the light receiving elements 140, and the optical paths which are disposed in the touch panel apparatus 1 according to Embodiment 1 of the present invention. The touch panel apparatus 1 according to the present invention has an operation plane formed in a rectangular shape, and the plurality of the light emitting devices 130, 130, . . . and the light receiving devices 140, 140, . . . are disposed around the operation plane. In the example illustrated in FIG. 5, the light emitting devices 130, 130, . . . are disposed along a lower side and a right side of the operation plane, and the light receiving devices 140, 140 are disposed along an upper side and a left side of the operation plane. In FIG. 5, arrows shown by a dotted line represents the optical path of the infrared light emitted from each light emitting device 130, 130, . . . . As illustrated in FIG. 5, the light emitting devices 130, 130, . . . which are disposed at the same side are arranged to have the optical paths parallel with each other. Further, each of the light emitting devices 130, 130, . . . and each of the light receiving devices 140, 140, . . . correspond to each other one by one, and the infrared light emitted from one light emitting device 130 is received by one light receiving device 140 corresponding thereto.

Herein, a direction parallel with the upper side of FIG. 5 is set to be an X-axis direction and a direction parallel with a left side is set to be a Y-axis direction. As described above, the light emitting unit 13 is connected to the first address decoder 15. The first address decoder 15 outputs the select signals sequentially scanned from the left to the right in the X-axis direction and from the top to the bottom in the Y-axis direction to the light emitting unit 13, so that each of the light emitting devices 130, 130, . . . sequentially emits light. The light emitting unit 13 has a multiplexer (not illustrated), which switches each of the light emitting devices 130, 130, . . . so as to sequentially emit light based on the select signal input from the first address decoder 15.

Further, the light receiving unit 14 is connected to the second address decoder 16. The second address decoder 16 outputs the select signals sequentially scanned from the left to the right in the X-axis direction and from the top to the bottom in the Y-axis direction to the light receiving unit 14, so that each of the light emitting devices 140, 140, . . . can sequentially receive light. The light receiving unit 14 has a multiplexer (not illustrated), which switches each of the light receiving devices 140, 140, . . . so as to sequentially receives light based on the select signal input from the second address decoder 16.

The light emitting devices 130, 130, . . . and the light receiving devices 140, 140, . . . are disposed along an X axis and a Y axis, and therefore the coordinate calculation unit 123 may calculate the positions of the light-shielding objects intercepting the optical path as an X coordinate and a Y coordinate.

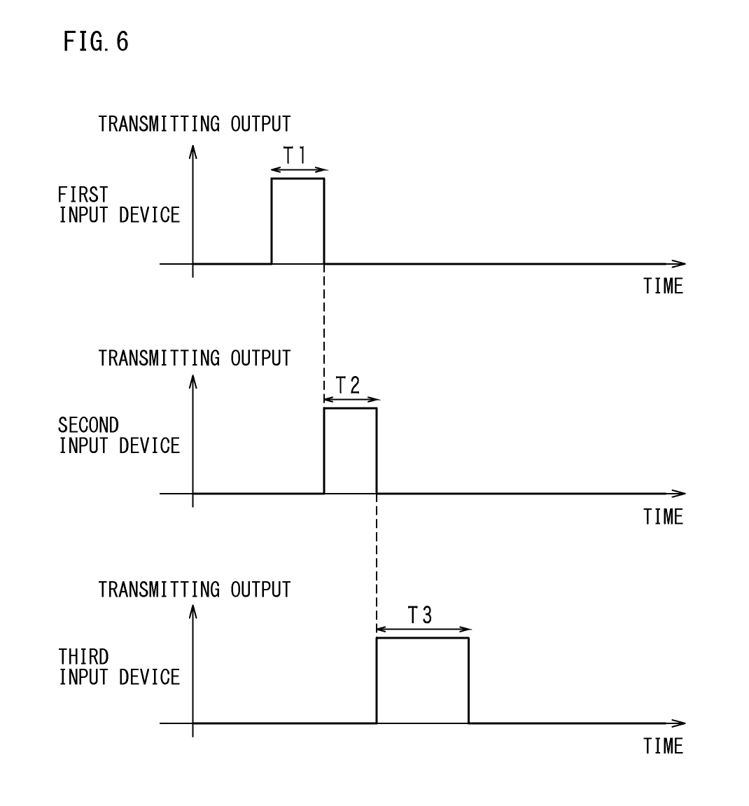

Next, processing of the input system according to Embodiment 1 of the present invention will be described. FIG. 6 is a timing chart sequentially illustrating an example of a transmission output of the status signals transmitted by the input devices 2, 2, . . . according to Embodiment 1 of the present invention. The timing chart illustrated in FIG. 6 illustrates transmitting outputs of a first input device 2a, a second input device 2b, and a third input device 2c from a top end to a bottom end. The transmission order of the status signals are determined in the first input device 2a, the second input device 2b, and the third input device 2c. As a method for determining the transmission order of the status signals, various methods may be used but these methods will be described in other Embodiments and in Embodiment 1, and processing after the transmission order is determined by a predetermined method will be described. Further, in the example illustrated in FIG. 6, the transmission order is considered to be determined in an order of the first input device 2a, the second input device 2b, and the third input device 2c.

When detecting a state in contact with the operation plane, each of the input devices 2, 2, . . . transmit the status signal representing the contact state. The status signal is transmitted as a pulse by on/off. A period of an on state representing the transmission time length of the status signal is preset for each of the input devices 2, 2, . . . and the set transmission time length is recorded in the recording unit 24. In the example illustrated in FIG. 6, the transmission time length of the first input device 2a is set to be T1, the transmission time length of the second input device 2b is set to be T2, and the transmission time length of the third input device 2c is set to be T3. As such, different transmission time lengths are preset for each of the input devices 2, 2, . . . , and are recorded in the recording unit 24 of each of the input devices 2, 2, . . . , including the transmission time lengths of other input devices 2, 2, . . . . Thereby, each of the input devices 2, 2, . . . may determine whether the transmitted status signal is the status signal transmitted from any other input device 2, 2 based on the transmission time lengths.

Each of the input devices 2, 2, . . . detect an end of transmission of the status signal from another input device 2 in which the immediately preceding transmission order is set and starts the transmission of the status signal based on the detection of the end of transmission. The end of transmission is decided by the detection that the status signal has shifted (hereinafter, referred to as a decay) from the on state to the off state. The decay of the status signals of other input devices 2, 2, . . . is detected by receiving the status signals transmitted from other input devices 2, 2, . . . by the communication unit 26, and comparing the intensity of the received status signal with a preset threshold value by the control unit 23. That is, the communication unit 26 and the control unit 23 serve as a signal detection unit which detects the end of transmission of other input devices 2, 2, . . . .

In the example illustrated in FIG. 6, the first input device 2a transmits the status signal, and when the transmission ends due to the elapse of a period of the transmission time length T1 from a start of transmission, the second input device 2b of which the determined transmission order is subsequent to the first input device 2a detects the decay so as to start the transmission of the status signal. Further, when the transmission ends due to the elapse of the transmitting time length T2 from the start of transmission of the second input device 2b, the third input device 2c of which the determined transmission order is subsequent to the second input device 2b detects the decay so as to start the transmission of the status signal. Further, it may be configured in such a manner that, the first input device 2a is set to be subsequent to the third input device 2c, and then setting an order may be performed so as to cyclically transmit the status signals.

According to the present invention, an edge at the time of the decay of one input device 2 is detected, and the transmission of the status signal from another input device 2 of which the determined transmission order is subsequent starts. Thereby, at the time of the switching of the input devices 2, 2, . . . which transmit the status signals, excellent effect of preventing the occurrence of a wasteful waiting time is exhibited. Further, after one input device 2 ends the transmission of the status signal, since another input device 2 starts the transmission of the status signal, excellent effects such as omitting a necessity to set the waiting time for preventing the status signals from overlapping are exhibited.

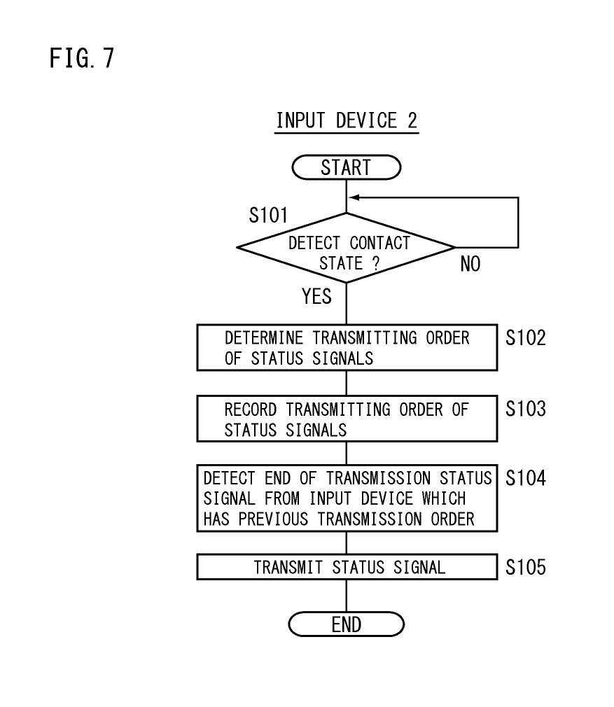

FIG. 7 is a flow chart illustrating an example of the transmission processing of the status signal from the input device 2 according to Embodiment 1 of the present invention. A flow of the processing of the input device 2 transmitting the above-described status signal will be described. The input device 2 executes the transmission processing of the status signal by the control of the control unit 23. That is, the control unit 23 determines whether the state detection unit 22 detects the contact state (S101).

When it is determined that the contact state is not detected (S101: NO), the control unit 23 repeats the processing of step S101.

When it is determined that the contact state is detected (S101: YES), the control unit 23 determines the transmission order of the status signals based on the relationship with other input devices 2, 2, . . . (S102), and records the determined transmission order in the recording unit 24 (S103).

The control unit 23 detects the end of transmission of the status signal from another input device 2 in which the previous transmission order is set, in cooperation with the communication unit 26 (S104), and transmits the status signal representing the contact state as a response of the detection of the end of transmission from the communication unit 26 (S105). Further, in the case in which the input devices 2, 2, . . . which are in the contact state are not present other than the input device 2 such as the case in which the transmission order other than the input device 2 is not determined in step S102, the case in which the status signal is not received from the other input devices 2, 2, . . . , or the like, the transmission of the status signal starts in step S104, without a need to perform the processing of step S103. Further, when the status signal is transmitted in step S105, processing of confirming that other status signals are not transmitted may be allowed to be added to avoid interference.

In addition, the control unit 23 repeats the transmission of the status signal based on the determined transmission order. Further, when the input device 2 is separated from the operation plane (pen up), the transmission processing of the status signal stops. Further, when a new pen down or a pen up of another input device 2 is detected, processing relating to re-determination and recording of the transmission order as interrupt processing is executed. In this way, the transmission processing of the status signal is executed.

Further, the processing illustrated in FIG. 7 is only an example, and therefore may be developed to involve various other processes. For example, the control unit 23 controls only the execution start and the execution stop of a transmission routine of the status signal, and the execution itself of the transmission processing may be allowed to be executed in a separated routine (or circuit), based on the detection results of the contact state. In this case, during the transmission routine of the status signal being executed, by the transmission routine, the processing of detecting the end of transmission of the status signal from another input device of which the previous transmission order is set, and transmitting the status signal during the transmission time length as a response of the detection is repeatedly executed.

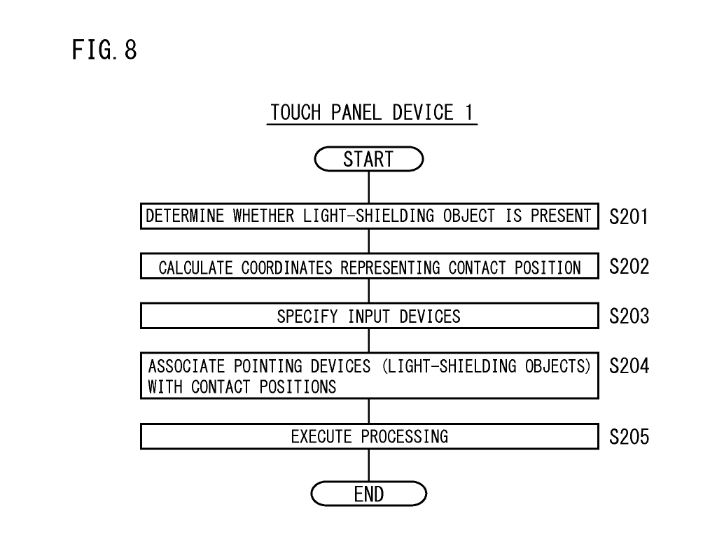

FIG. 8 is a flow chart illustrating an example of processing of detecting an input position of the touch panel apparatus 1 according to Embodiment 1 of the present invention. As described above, the touch panel apparatus 1 communicating with the plurality of input devices 2, 2, . . . transmitting the status signals executes the processing of detecting the input positions by the input devices 2, 2, . . . by the control of the control unit 12. That is, the control unit 12 determines whether the light-shielding object contacting the operation plane is present (S201), and when it is determined that the contacting light-shielding object is present, calculates coordinates representing the contacting position (S202).

Further, the control unit 12 receives the status signals respectively transmitted from the input devices 2, 2, . . . through the communication unit 19, and specifies the contacting input devices 2, 2, . . . based on the received status signals (S203). The touch panel apparatus 1 records the information regarding the transmission order, the transmitting time length, and the like which are obtained by communication with the input devices 2, 2, . . . through the communication unit 19 in the memory 121. Therefore, what input device 2 newly contacts, what input device 2 continuously contacts, and what input device 2 is separated may be specified based on the received status signal. Further, in the case in which the input device 2 relating to the light-shielding object contacting the operation plane may not be specified such as a case in which the status signal is not received, it is determined that the corresponding light-shielding object are not the input device 2.

The control unit 12 associates the light-shielding objects such as the contacting input devices 2, 2, . . . , with the contact positions (S204), and records the results thereof in the memory 121. When the newly contacting input device 2 is associated with the contact position, the traces of the contacting positions are sequentially tracked and recorded, and thus the relationship between the input device 2 and the contact position may be held, and a new input device 2 may be distinguished when it contacts the operation plane.

And then, the control unit 12 executes various processes on the contact positions as the input positions from the light-shielding objects such as the corresponding input devices 2, 2, . . . (S205). For the processing after the input device 2 corresponding to the contact position is specified, various techniques may be used.

As described above, the input system according to Embodiment 1 of the present invention transmits and receives the status signals in a time division manner in cooperation with the plurality of input devices 2, 2, . . . . Thereby, excellent effects such as preventing the status signals from interfering with each other are exhibited. Further, since the status signal is a simple pulse, excellent effects such as omitting a necessity of the encode/decode processing at the time of transmitting and receiving the status signal and preventing a processing load from increasing are exhibited. Further, since any signal is not always transmitted, excellent effects such as reducing electrical energy required for the transmission are exhibited. In addition, as described above, various effects such as preventing the occurrence of the waiting time and omitting the setting of the waiting time are exhibited.

### Embodiment 2

Embodiment 2 has a configuration in which the operation signal and the status signal are divided, when the switches such as the first switch SW1 and the second switch SW2 of input devices 2 are pressed and the operation signal such as changes in the kinds of line is transmitted, in Embodiment 1. Further, in the following description, the components and processing having functions common to Embodiment 1 are denoted by the same reference numerals as Embodiment 1, and therefore will not be described in detail. In Embodiment 2, the appearance and the internal configuration of the input system are the same as Embodiment 1 and therefore are referenced by those described in Embodiment 1 and will not be described.

In Embodiment 2, the contact signal representing the contact condition with the operation plane of the touch panel apparatus 1 and the operation signal representing that the switches such as the first switch SW1 and the second switch SW2 are pressed are set as a differentiable signal. In detail, the status signal and the operation signal are defined by the pulse signal which is intermittently turned on/off and at least one of pulse widths, pulse periods, and transmission time lengths of the status signal and the operation signal for each of the input devices 2, 2, . . . is defined differently.

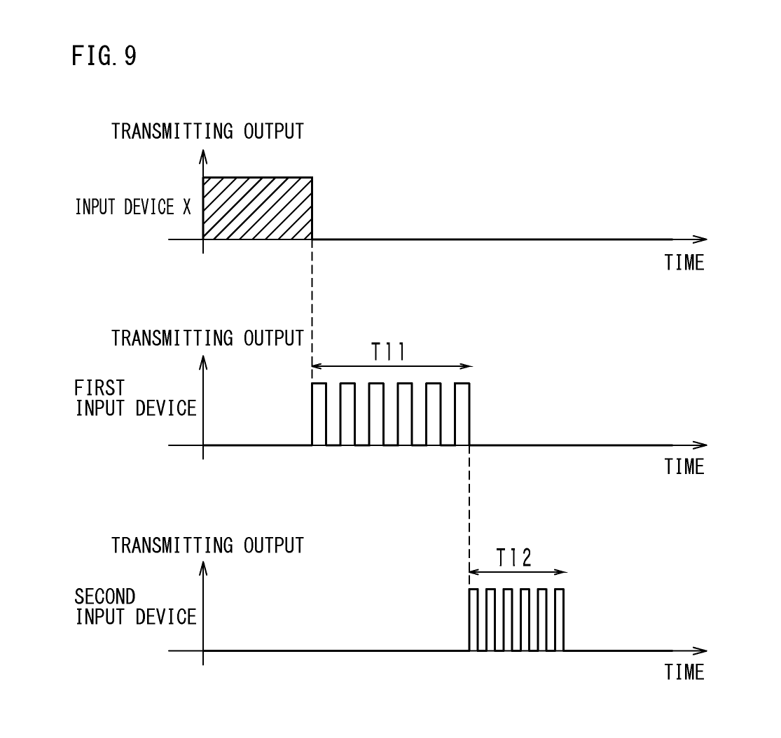

FIG. 9 is a timing chart sequentially illustrating an example of the transmission output of the status signals and the operation signals transmitted by the input devices 2, 2, . . . according to Embodiment 2 of the present invention. The timing chart illustrated in FIG. 9 represents the transmission output of the first input device 2a in a middle portion and the transmission output of the second input device 2b in a lower portion. Further, the upper portion represents the transmission output by another input device 2 (input device X) which is repressed as a reference for expressing clearly the start of transmission timing from the first input device 2a.

An example illustrated in FIG. 9 represents an example in which the status signal and the operation signal are specified by the transmission time length. In the example illustrated in FIG. 9, the first input device 2a and the second input device 2b are specified by the pulse width and the pulse period. In the example illustrated in FIG. 9, in the case of the status signal representing the contact state, the transmission time length becomes T11 and in the case of the operation signal, the transmission time length becomes T12. Other input devices 2, 2, . . . and the touch panel apparatus 1 which receive some signal from the first input device 2a or the second input device 2b specify whether a transmission source is the first input device 2a or the second input device 2b by the pulse width and the pulse period, and specify whether it is the status signal or the operation signal by the transmission time length. Further, in the contact state and the operating state, the transmission time length may be appropriately designed to alternately transmit the signal having a transmission time length of T11 and the signal having a transmission time length of T12, separately set the transmission time length or the like. Further, other switches such as the first switch SW1 and the second switch SW2 may correspond to a plurality of operations by setting the transmission time length through the operations such as the simultaneous pressing and the continuous pressing.

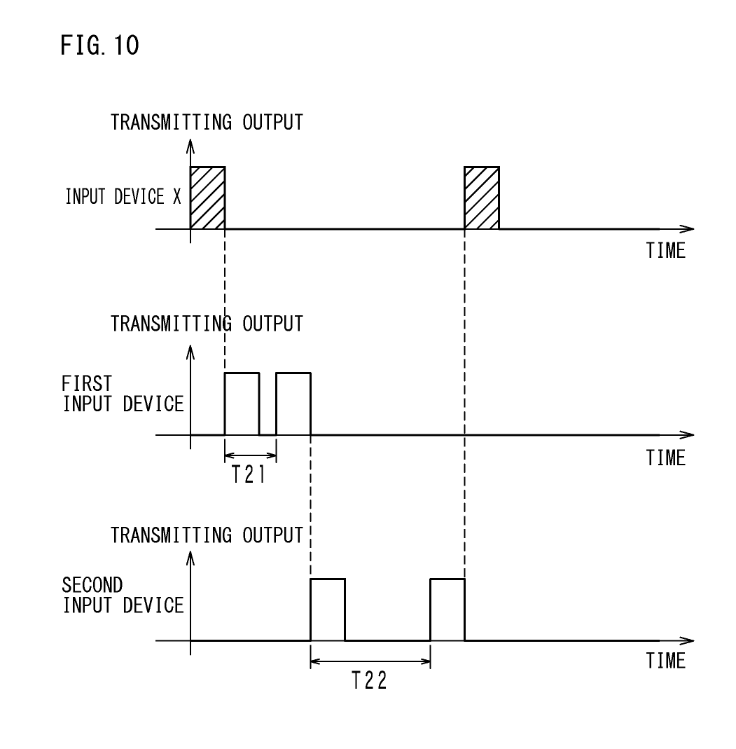

FIG. 10 is a timing chart sequentially illustrating an example of the transmission output of the status signals and the operation signals transmitted by the input devices 2, 2, . . . according to Embodiment 2 of the present invention over time. FIG. 10 is a different example from FIG. 9 and illustrates an example of specifying the status signals and the operation signals by the pulse period. In the example illustrated in FIG. 10, the first input device 2a and the second input device 2b are specified by the pulse width and the transmission time length. In the example illustrated in FIG. 10, in the case of the status signal representing the contact state, a pulse period in which the status signal is shifted from the off state to the on state (hereinafter, referred to as rising) and then reaches the subsequent rising becomes T21. Further, in the case of the operation signal, the pulse period becomes T22. Other input devices 2, 2, . . . and the touch panel apparatus 1 which receive some signal from the first input device 2a or the second input device 2b specify whether the transmission source is the first input device 2a or the second input device 2b by the pulse width and the transmission time length, and specify whether it is the status signal or the operation signal by the pulse period. Further, it is not specified by the pulse period from the rising to the subsequent rising, but may be specified by an off continuous time from the decay to the subsequent rising. The off continuous time is uniquely specified by the pulse period and the pulse width.

In Embodiment 2, the input devices 2, 2, . . . and the kind of signals are specified based on a pulse wave which is defined by the pulse width, the pulse period, and the transmission time length. What pulse wave is transmitted in some state may be appropriately set, and a considerable number of operation signals may be defined depending on specifications such as an identification resolving power. Therefore, the input system according to Embodiment 1 of the present invention may be developed to a configuration of also transmitting the operation signal by applying Embodiment 2.

### Embodiment 3

Embodiment 3 has a configuration in which the status signal transmitted as the pulse signal is modulated to set a serial communication based on various kinds of information such as the contact state, the operation state, and an identifier, in Embodiment 1. Further, in the following description, the components and processing having functions common to Embodiments 1 and 2 are denoted by the same reference numerals as the Embodiments 1 and 2, and therefore will not be described in detail. In Embodiment 3, the appearance and the internal configuration of the input system are the same as Embodiment 1 and therefore are referenced by those described in Embodiment 1 and will not be described.

In Embodiment 3, the initial status signal is set as the pulse signal which is intermittently turned on/off. Further, the status signal is subjected to encode processing for modulating by the contact condition with the operation plane of the touch panel apparatus 1, the operation received by the switch such as the first switch SW1, and the setting relating to the input device such as the identifier of the input device 2, and thereby executing the serial communication. For example, “0” or “1” may be represented by the pulse width from rising to decay of the pulse by modulating the pulse width of the pulse signal set as the initial status signal. Further, information such as the contact state to the operation plane of the touch panel apparatus 1, the operation state of the first switch SW1, and the like, the identifier of the input device 2 may be appropriately recorded in the recording unit 24.

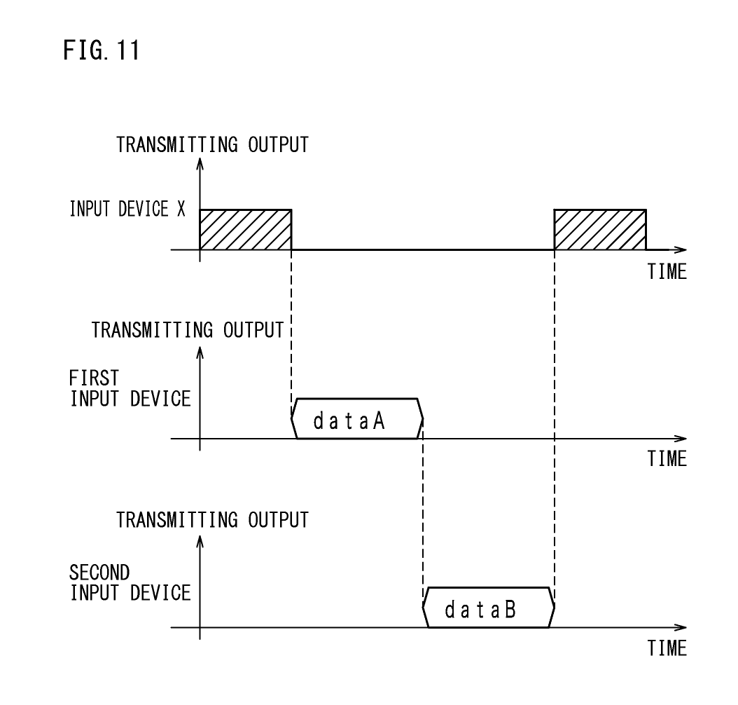

FIG. 11 is a timing chart sequentially illustrating an example of the transmission output of the status signals transmitted by the input devices 2, 2, . . . according to Embodiment 3 of the present invention. The timing chart illustrated in FIG. 11 represents the transmission output of the first input device 2a in a middle portion and represents the transmission output of the second input device 2b in a lower portion. Further, the upper portion represents the transmission output by another input device 2 (input device X) which is represented as a reference for expressing clearly the start of transmission timing from the first input device 2a. As illustrated in FIG. 11, the start of transmission time of the status signal is the same as that of Embodiment 1. However, a format of the status signals represented as data A and data B is a modulated pulse wave.

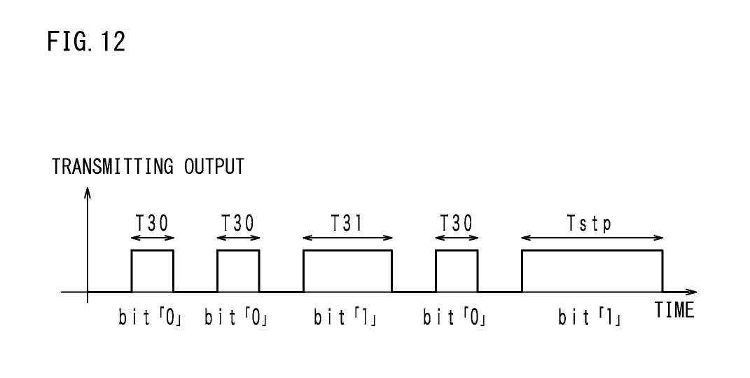

FIG. 12 is a diagram for describing an example of a format of the status signal according to Embodiment 3 of the present invention. FIG. 12 is a diagram illustrating the format of the status signal, which is represented as the data A in FIG. 11, in a timing chart format. The status signal illustrated in FIG. 12 is a signal generated by modulating four pulses with a 4 bit signal representing the contact state, the operation state, and the identifier, and is finally added with a pulse corresponding to a stop bit. Each pulse corresponds to each bit signal. The example illustrated in FIG. 12 illustrates the contact state of the first bit. For example, when a first bit is “1”, it represents that the first input device 2a is in contact with the operation plane, and when the first bit is “0”, it represents that the first input device 2a is not in contact with the operation plane. The second bit represents the operation state of the switch (operation unit) such as the first switch SW1. A third bit and a fourth bit represent the setting relating to the first input device 2a, that is, the identifier herein. A fifth bit is a stop bit. In the example illustrated in FIG. 12, a pulse width representing “0” is T30 and a pulse width representing “1” is T31. In addition, the stop bit represents a pulse width of Tstp. Further, it may be appropriately set in such a manner that “0” or “1” is represented by the width from rising to rising of the subsequent bit.”

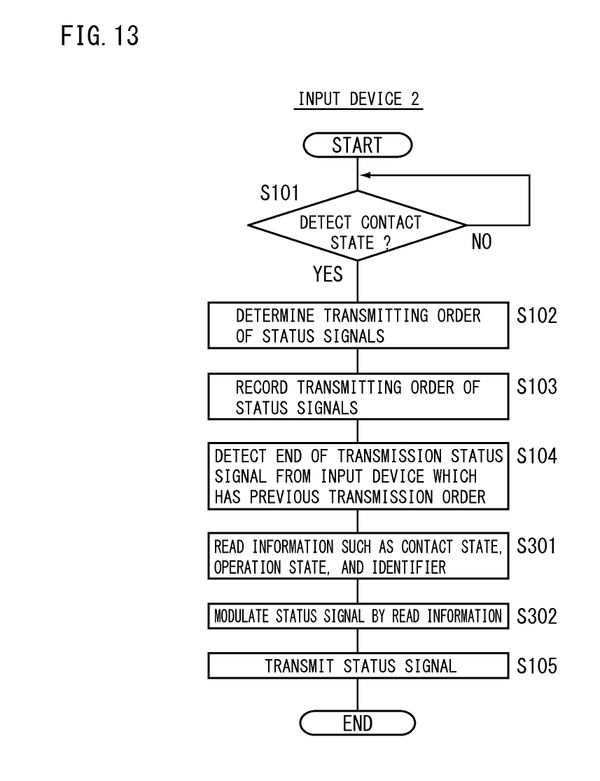

FIG. 13 is a flow chart illustrating an example of the transmission processing of the status signals from the input device 2 according to Embodiment 3 of the present invention. Further, a part of the procedures of the transmission processing illustrated in the flow chart of FIG. 13 overlaps a part of the procedures illustrated in FIG. 7, and therefore the overlapping procedures are denoted by the same step number as FIG. 7.

The control unit 23 of the input device 2 determines whether the state detection unit 22 detects the contact state (S101). When it is determined that the contact state is not detected (S101: NO), the control unit 23 repeats the processing of step S101.

When it is determined that the contact state is detected (S101: YES), the control unit 23 determines the transmission order of the status signals based on the relationship with other input devices 2, 2, . . . (S102), and records the determined transmission order in the recording unit 24 (S103).

When the end of transmission of the status signal from another input device 2 of which the previous transmission order is set is detected, in cooperation with the communication unit 26 (S104), the control unit 23 reads the required information such as the contact state, the operation state, and the identifier from the recording unit 24 (S301).

Next, the control unit 23 modulates (encodes) the pulse signal set as the initial status signal by the read information (S302). Then, the control unit 23 performs the processing of transmitting the modulated status signal through the communication unit 26 (S105). Further, the touch panel apparatus 1 and other input devices 2, 2, . . . which receive the status signal decode the received status signal and perform processes. Further, the stop bit may also be recognized by the starting processing of the status signal by another input device 2. In this way, the encode processing is executed.

Further, the modulation by the information such as the contact state is not limited to the modulation for the pulse width, and may be developed to the pulse period and various other identifiable encode processes. Further, the information used in the modulation may be appropriately set, and is not necessarily limited to the above-described information.

As described-above, in Embodiment 3, the status signal is modulated depending on the information to be transmitted, and thus the information such as the contact state, the operation state, and the identifier may be transmitted in a collective manner. Further, when Embodiment 3 is applied, since the input device 2 may be specified by the identifier, it is possible to constantly maintain the transmission time length.

### Embodiment 4

Embodiment 4 has a configuration illustrating an example of a method for determining the set transmission order, in Embodiment 1. Further, in the following description, the components and processing having functions common to Embodiments 1 to 3 are denoted by the same reference numerals as the Embodiments 1 to 3, and therefore will not be described in detail. In Embodiment 4, the appearance and the internal configuration of the input system are the same as Embodiment 1 and therefore are referenced by those described in Embodiment 1 and will not be described.

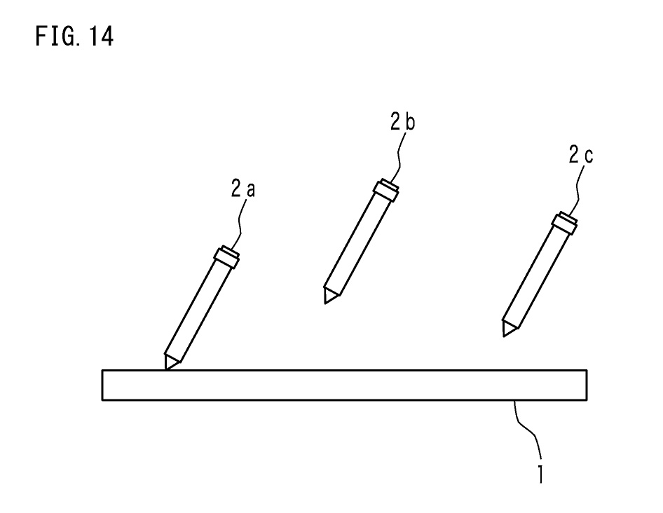

FIG. 14 is a schematic diagram schematically illustrating an example of a contact condition of the touch panel apparatus 1 and input devices 2, 2, . . . in the input system according to Embodiment 4 of the present invention. FIG. 14 illustrates the contact relationship between the operation plane of the touch panel apparatus 1 and a first input device 2a, a second input device 2b, and a third input device 2c. FIG. 14 illustrates the condition that the first input device 2a previously contacts the operation plane of the touch panel apparatus 1, and then the third input device 2c and the second input device 2b contact the operation plane in this order.

In Embodiment 4, in the case of the condition illustrated in FIG. 14, the set transmission order is determined in an order of the first input device 2a, the third input device 2c, and the second input device 2b. However, since the contact condition with the operation plane needs to be recognized by other input devices 2, 2, . . ., it is implemented by, for example, the processing of determining the transmission order in an order in which each of the input devices 2, 2, . . . transmits the status signals. In this case, each of the input devices 2, 2, . . . determines the transmission order based on the transmitting timing of the status signals by the input devices 2, 2, . . . and the receiving timing of the status signals transmitted from other input devices 2, 2, . . . . Further, for example, the touch panel apparatus 1 may be configured so as to determine the transmission order in an order of receiving the status signals from each of the input devices 2, 2, . . . , and transmit the determined transmission order from the touch panel apparatus 1 to each of the input devices 2, 2, . . . .

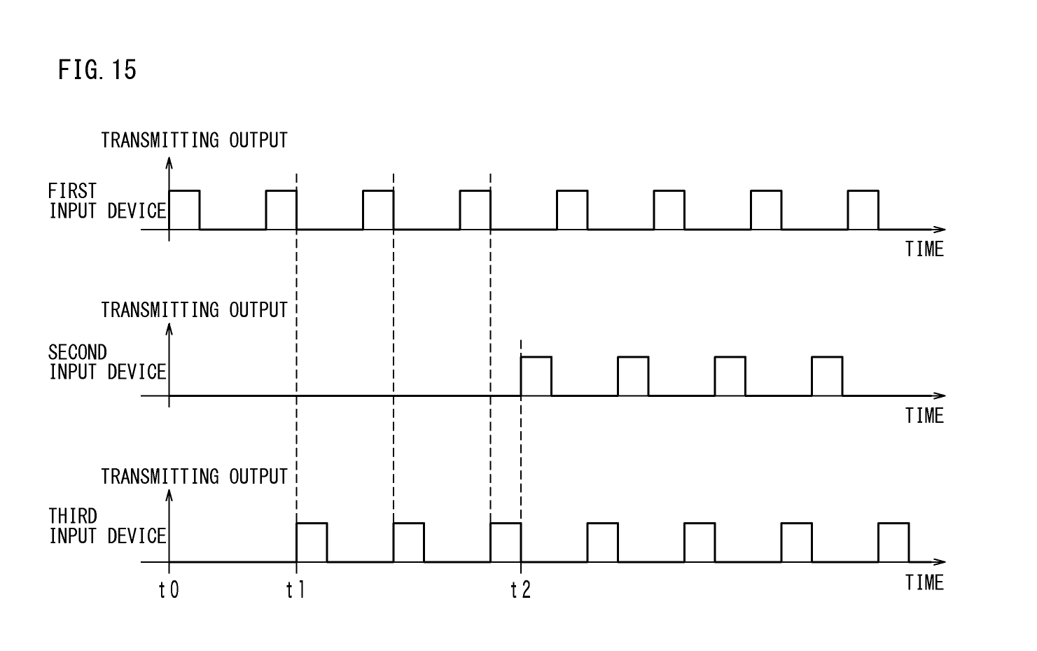

FIG. 15 is a timing chart sequentially illustrating an example of the transmission output of the status signals transmitted by the input devices 2, 2, . . . according to Embodiment 4 of the present invention over time. The timing chart illustrated in FIG. 15 illustrates the transmitting outputs of the first input device 2a, the second input device 2b, and the third input device 2c from the upper-row to the lower-row. Since only the first input device 2a is in contact with the operation plane in a period until the third input device 2c transmits a first status signal at timing t1 after the first input device 2a contacts with the operation plane at timing t0, only the first input device 2a transmits the status signal at a fixed period. Further, the first input device 2a and the third input device 2c alternately transmit the status signal in a period until the second input device 2b transmits the first status signal at timing t2 after the third input device 2c contacts with the operation plane and the first status signal is transmitted at the timing t1. In addition, after the timing t2 at which the second input device 2b contacts with the operation plane and the first status signal is transmitted, the first input device 2a, the third input device 2c, and the second input device 2b transmit the status signals in this order. Therefore, in Embodiment 4, the transmission order is determined in the order in which the status signals are transmitted. Further, when becoming the non-contacting state (pen up) from the contacting state (pen down), the transmission order is changed in a filling forward manner.

Further, as illustrated in FIG. 15, a transmission period in which the status signal is transmitted is set based on a state in which all the input devices 2, 2, . . . contact the operation plane, and thereby the status signals may be continuously transmitted at a constant period even when the input devices 2, 2, . . . newly contact the operation plane. The input device 2 continuously transmits the status signal at a constant transmission period, and thus a response of the drawing based on the contact trace of the input device 2 is uniform. Therefore, it is possible to provide an easy writing.

### Embodiment 5

Embodiment 5 has a configuration in which the time until the start of transmitting the status signal after the detection of the contact is set differently in each of the input devices when compared to Embodiment 1. Further, in the following description, the components and processing having functions common to Embodiments 1 to 4 are denoted by the same reference numerals as the Embodiments 1 to 4, and therefore will not be described in detail. In Embodiment 5, the appearance and the internal configuration of the input system are the same as Embodiment 1 and therefore are referenced by those described in Embodiment 1 and will not be described.

Embodiment 5 has, for example as described in Embodiment 4, a configuration in which, when the contact is detected to first transmit the status signal, a time until the transmission of the first status signal after the detection (pen down) of the contact is set to be different values for the each of the input devices 2, 2, . . . . In detail, the configuration is implemented by performing delay processing to set different waiting times to each of the input device 2, 2, . . . in a time until a notification of the detection to the control unit 23 after the state detection unit 22 detects the contact or a time until a transmission of the status signal to the communication unit 26 after the control unit 23 recognizes the contact.

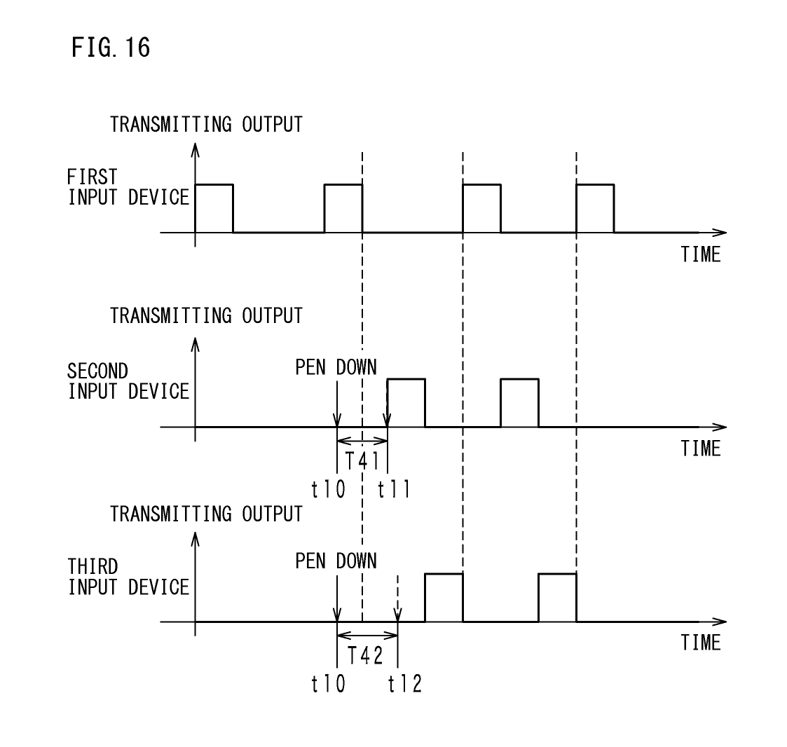

FIG. 16 is a timing chart sequentially illustrating an example of the transmission output of the status signals transmitted by the input devices 2, 2, . . . according to Embodiment 5 of the present invention over time. The timing chart illustrated in FIG. 16 illustrates the transmission outputs of the first input device 2a, the second input device 2b, and the third input device 2c from the upper-row to the lower-row. FIG. 16 illustrates the processing of the state in which the second input device 2b and the third input device 2c are simultaneously pen-downed at timing t10 from the condition in which only the first input device 2a is in contact with the operation plane. In the second input device 2b and the third input device 2c, the time until the transmission of the status signals after the pen down in which the state detection unit 22 detects the contact state is set differently. In the example illustrated in FIG. 16, the waiting time is set as T41 in the second input device 2b, and the waiting time is set as T42 in the third input device 2c, which is a longer time than T41.

As exemplified in FIG. 16, the second input device 2b starts the transmission of the status signal at timing t11 at which the time T41 elapses from the pen down, and thereby, is determined as the subsequent transmission order of the first input device 2a. The third input device 2c becomes the timing at which the status signal may be transmitted at the timing t12 at which the time T42 elapses from the pen down, but becomes the waiting state due to the status signal is transmitting from the second input device 2b at the step of the timing t12. Further, the third input device 2c detects the end of transmission of the status signal from the second input device 2b, and then transmits the status signal. Thereby, the transmission order is determined as an order of the first input device 2a, the second input device 2b, and the third input device 2c.

In Embodiment 5, even though the plurality of input devices 2, 2, . . . are simultaneously pen-downed, it is possible to prevent the status signals from being simultaneously redundantly transmitted.

### Embodiment 6

Embodiment 6 has a configuration in which the time until the start of transmitting the status signals after the detection of the end of transmission of the status signals from other input devices is set differently in each of the input device, not the time until the start of transmitting the status signals after the detection of the contact, as described in Embodiment 5. Further, in the following description, the components and processing having functions common to Embodiments 1 to 5 are denoted by the same reference numerals as the Embodiments 1 to 5, and therefore will not be described in detail. In Embodiment 6, the appearance and the internal configuration of the input system are the same as Embodiment 1 and therefore are referenced by those described in Embodiment 1 and will not be described.

Embodiment 6 has a configuration in which the time until transmitting the first status signal after the detection of the end of transmitting the status signal from the input device 2 that is already in contact is set differently in each of the input device 2, 2, . . . as a waiting time, when transmitting the status signal after detecting the contact.

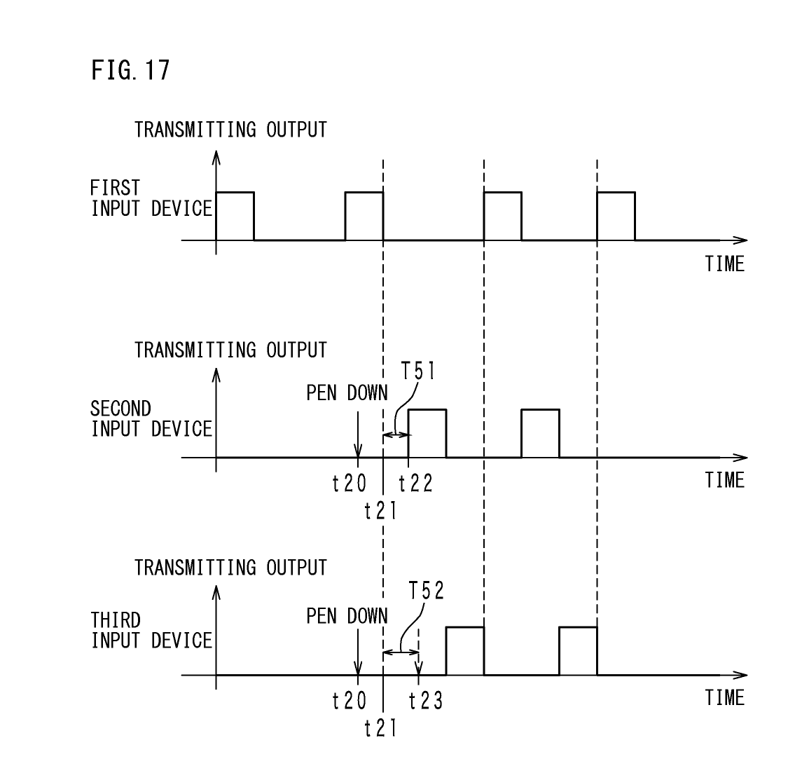

FIG. 17 is a timing chart sequentially illustrating an example of the transmission output of the status signals transmitted by the input devices 2, 2, . . . according to Embodiment 6 of the present invention over time. The timing chart illustrated in FIG. 17 illustrates the transmission outputs of the first input device 2a, the second input device 2b, and the third input device 2c from the upper-row to the lower-row. FIG. 17 illustrates the processing of the state in which the second input device 2b and the third input device 2c are simultaneously pen-downed at timing t20 from the condition in which only the first input device 2a is in contact with the operation plane. The waiting time is set differently in the second input device 2b and the third input device 2c, respectively, from detecting the end of transmission of the status signal transmitted by the first input device 2a already contacting the operation plane to transmitting their own first status signal. In the example illustrated in FIG. 17, the waiting time is set as T51 in the second input device 2b, and the waiting time is set as T52 in the third input device 2c, which is a longer time than T51

As exemplified in FIG. 17, the second input device 2b waits from the timing t21 at which the end of transmission of the input device 2, herein, the first input device 2a of which the transmission order is last among the input devices 2, 2, . . . that is already in contact at the time of the pen down is detected to the time T51. In addition, the third input device 2c waits from the timing t21 at which the end of transmission of the first input device 2a is detected to the time T52. Further, the second input device 2b starts the transmission of the status signal at the timing t22 at which the time T51 elapses, and thereby, is determined as the subsequent transmission order of the first input device 2a. The third input device 2c may transmit the status signal at the timing from the timing t21 at which the end of transmission of the first input device 2a is detected to the timing t23 at which the time T52 elapses, but is in the waiting state due to the status signal is transmitting from the second input device 2b at the timing t23. Further, the third input device 2c detects the end of transmission of the status signal from the second input device 2b, and then transmits the status signal. Thereby, the transmission order is determined as an order of the first input device 2a, the second input device 2b, and the third input device 2c.

Therefore, in Embodiment 6, even though the plurality of input devices 2, 2, . . . are simultaneously pen-downed, it is possible to prevent the status signals from being simultaneously redundantly transmitted.

### Embodiment 7

Embodiment 7 has a configuration in which the set transmission order is determined in an order in which the infrared light emitted from the light emitting devices of the touch panel apparatus is detected, not the contact order to the operation plane, as described in Embodiment 4. Further, in the following description, the components and processing having functions common to Embodiments 1 to 6 are denoted by the same reference numerals as the Embodiments 1 to 6, and therefore will not be described in detail. In Embodiment 7, the appearance and the internal configuration of the input system are the same as Embodiment 1 and therefore are referenced by those described in Embodiment 1 and will not be described.

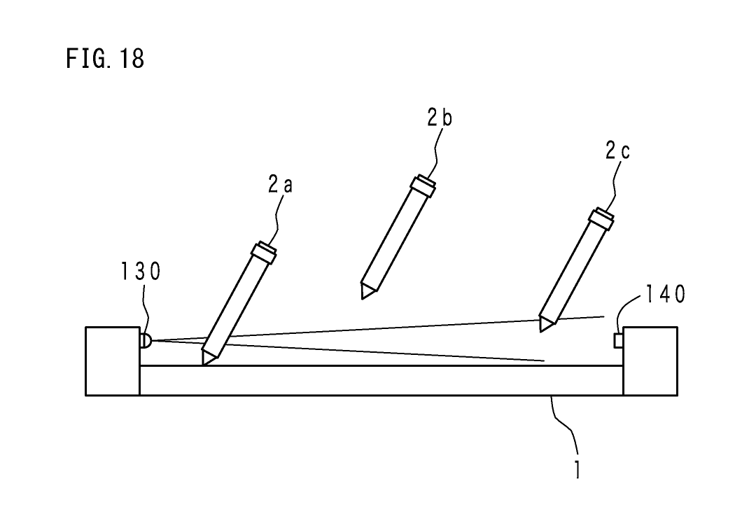

FIG. 18 is a schematic diagram schematically illustrating an example of the contact condition of the touch panel apparatus 1 and the input devices 2, 2, . . . in the input system according to Embodiment 7 of the present invention. FIG. 18 illustrates the contact relationship among the operation plane of the touch panel apparatus 1, a light emitting device 130 and a light receiving device 140, and a first input device 2a, a second input device 2b, and a third input device 2c. FIG. 18 illustrates the condition that the first input device 2a already contacts the operation plane of the touch panel apparatus 1, and then the third input device 2c and the second input device 2b contact the operation plane in this order. Further, in Embodiment 4, it is determined that the contact is made when the contact of the input devices 2, 2, . . . with the operation plane is detected, but in Embodiment 7, it is determined that the contact is made when the input devices 2, 2, . . . detect the infrared light emitted from the light emitting device 130.

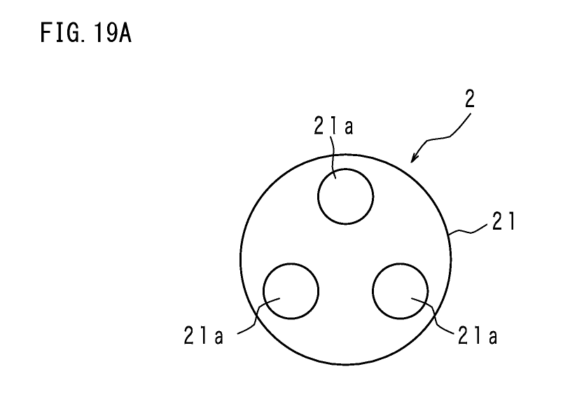

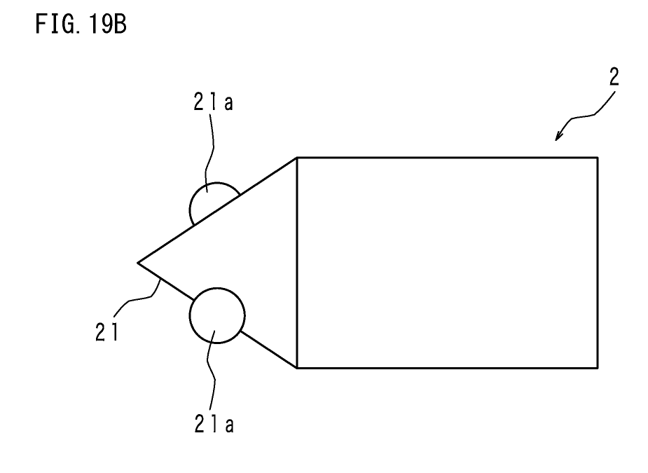

FIG. 19 are schematic views illustrating an example of the input device 2 according to Embodiment 7 of the present invention. FIG. 19A is a front view of the input device 2 as seen from a pen tip part 21 side thereof in an axial direction, and FIG. 19B is a side view illustrating a portion of a main body part 20 and the pen tip part 21 of the input device 2. As illustrated in FIGS. 19A and 19B, the pen tip part 21 formed in a conical shape of the input device 2 includes three hemispherical light receiving devices 21a, 21a, and 21a (second detection unit) disposed uniformly. Each of the light receiving devices 21a, 21a, and 21a serves as the state detection unit which detects the contact state based on the receiving condition of the infrared light. Further, each of the light receiving devices 21a, 21a, and 21a may not serve as the state detection unit, and therefore the circuit inside the main body part 20 receiving the light receiving signal for representing ones receiving light which is output from the light receiving devices 21a, 21a, and 21a may also served as the state detection unit 22 (see FIG. 3). Further, the state detection unit 22 inside the main body part 20 is configured as a light receiving device, and lighting windows through which the infrared light may be provided at positions of the light receiving devices 21a, 21a, and 21a illustrated in FIGS. 9A and 9B.

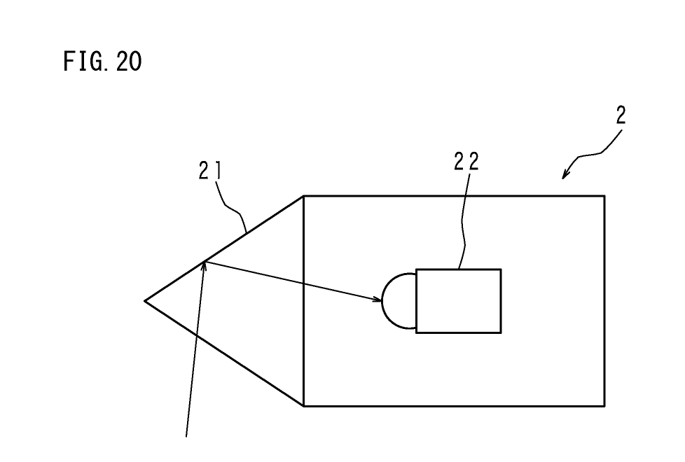

FIG. 20 is a schematic diagram illustrating an example of the input device 2 according to Embodiment 7 of the present invention. FIG. 20 is a schematic diagram illustrating the state detection unit 22 which is disposed in the main body part 20 of the input device 2. In FIG. 20, the state detection unit 22 may be configured using the light receiving device and a side of the pen tip part 21 formed in the conical shape may be configured using a half mirror which may conduct the infrared light from an outside. Further, the state detection unit 22 receives the infrared light conducted from the side of the pen tip part 21 to detect that the input device contacts the operation plane. Other processing refers to, for example, Embodiment 4 and therefore the description thereof will not be described in detail.

Embodiments 1 to 7 illustrate only some of infinite potential forms of the present invention and the setting of a configuration of various systems, the configuration of hardware, information processing by software, conditions of the processing, and the like may be appropriately designed according to a purpose, a usage and the like. Further, Embodiments 1 to 7 are each executed alone, but may be executed by being appropriately combined.

For example, Embodiments 1 to 7 describe the configuration in which they are applied to a display of a computer, but the present invention is not limited thereto, and therefore may not only be applied to a display of other apparatuses such as a television broadcasting receiver, but may also be applied to various apparatuses which may be used as an input device, and the like of an apparatus which does not have a display screen.

### DESCRIPTION OF REFERENCE NUMERALS

1 touch panel apparatus

10 display panel

11 input panel

12 control unit

120 processor

121 memory

122 driving control unit

123 coordinate calculation unit

124 light-shielding object management unit

13 light emitting unit

130 light emitting element

14 light receiving unit

140 light receiving element

15 first address decoder

16 second address signal

17 AD converter

18 interface unit

19 communication unit

2 input device

20 main body part

21 pen tip part

22 state detection unit

23 control unit

24 recording unit

25 switch detection unit

26 communication unit

3 computer

4 first cable

5 second cable

PRG program

SW1 first switch

SW2 second switch

1-10. (canceled)

11. An input system comprising:
a plurality of input devices that communicate with a touch panel apparatus and are used to point out positions on a display screen of the touch panel apparatus, wherein
each of the input devices includes:
a transmitting unit configured to transmit a status signal representing a contact state of the input device with the display screen;
a determination unit configured to determine a transmission order of the status signal based on a relationship with other input devices; and
a signal detection unit configured to detect an end of transmission of the status signal from another input device of which the determined transmission order is previous, and
the touch panel apparatus includes:
a position detection unit configured to detect a position as an input position of the input device that is a transmission source of the status signal, when the touch panel apparatus receives the status signal representing the contact state of the input device with the display screen and detects a contact of the input device with the display screen.

12. The input system according to claim 11, wherein
a transmission time length of the status signal is set to different time lengths for each of the input devices.

13. The input system according to claim 11, wherein
each of the input devices further comprises a first detection unit configured to detect a contact with the display screen,
the transmitting unit is configured to transmit the status signal when the first detection unit detects that the input device is in contact with the display screen, and
the determination unit is configured to determine a transmission order of the status signals of the respective input devices based on order in which the input devices transmit the status signals or order in which the touch panel apparatus receives the status signals.

14. The input system according to claim 11, wherein
the touch panel apparatus further includes:
a plurality of light emitting devices disposed around the display screen; and
a plurality of light receiving devices respectively corresponding to the plurality of light emitting devices, wherein
the touch panel apparatus detects a position in which the input device contacts with the display screen based on a result that light emitted from each of the light emitting devices is respectively received in the light receiving devices corresponding thereto, and
each of the input devices further comprises a second detection unit configured to detect the light emitted from each of the light emitting devices,
the transmitting unit is configured to transmit the status signal when the second detection unit detects the light, and
the determination unit is configured to determine the transmission order of the status signals of the respective input devices based on order in which the input devices transmit the status signals or order in which the touch panel apparatus receives the status signals.

15. The input system according to claim 13, wherein
a time at which the transmission of the status signal starts after the first detection unit detects that the input device is in contact with the display screen is set differently in each of the input devices.

16. The input system according to claim 11, wherein
a time at which the transmission of the status signal starts after the signal detection unit detects the end of the transmission is set differently in each of the input devices.

17. The input system according to claim 11, wherein
each of the input devices further includes an operation unit configured to receive an operation,
the transmitting unit is configured to transmit an operation signal when the operation unit receives the operation, and
the status signal and the operation signal are pulse signals of which at least one of a pulse width, a pulse period, and a transmission time length is different.

18. The input system according to claim 11, wherein
the status signal is a pulse signal,
each of the input devices further includes:
an operation unit configured to receive an operation; and
a modulation unit configured to modulate a pulse signal by at least one of the contact state of the input device with the display screen, the operation received by the operation unit, and a setting relating to the input device itself.

19. A non-transitory recording medium readable by a computer in which a computer program for controlling an operation of a plurality of input devices is recorded, in an input system in which a touch panel apparatus having a display screen and the plurality of input devices used to point out positions on the display screen are configured to respectively communicate with each other and detect a contact position of each input devices on the display screen as an input position,
said computer program executing:
determining a transmission order of status signals representing a contact state with the display screen based on a relationship with other input devices;
detecting an end of transmission of the status signals of other input devices of which the determined transmission order is previous; and
starting the transmission of the status signals based on the detection of the end of the transmission of the status signals of other input devices.
